(19) United States
(12) Patent Application Publication
(10) Pub. No.: US 2005/0181239 A1
(43) Pub. Date: Aug. 18, 2005

(54) Granular magnetic recording media with improved corrosion resistance by pre-carbon overcoat ion etching

(75) Inventors: Xiaoding Ma, Fremont, CA (US); Michael Joseph Stirniman, Fremont, CA (US); Raj Thangaraj, Fremont, CA (US); Jing Gui, Fremont, CA (US); Tom Patrick Nolan, Fremont, CA (US); Huan Tang, Los Altos, CA (US)

Correspondence Address: MCDERMOTT, WILL & EMERY, 600 13th Street, N.W., Washington, DC, 20005-3096, US

(73) Assignee: SEAGATE TECHNOLOGY LLC

(21) Appl. No.: 10/776,223

(22) Filed: Feb. 12, 2004

(51) Int. Cl. G11B 7/24; B05D 5/12

(52) U.S. Cl. 428/835; 427/128; 427/131; 427/132; 428/835.8; 428/846.7; 428/846.9; 428/836.1

(57) ABSTRACT

A granular longitudinal or perpendicular magnetic recording medium with enhanced corrosion resistance comprises: (a) a non-magnetic substrate having a surface; (b) a layer stack on the substrate surface, including a granular longitudinal or perpendicular magnetic recording layer having a surface distal the substrate surface treated to provide at least one of: (i) a reduction of nano-scale roughness and porosity; (ii) increased compositional homogeneity; (iii) increased microstructural homogeneity; (iv) preferential removal of at least one element; and (v) increased grain boundary coverage by the subsequently deposited protective overcoat layer; and (c) a protective overcoat layer on the treated surface of the granular magnetic recording layer.

### FIELD OF THE INVENTION

The present invention relates to methods for improving the corrosion resistance of thin film magnetic recording media and to magnetic recording media obtained thereby. The invention has particular utility in the manufacture of high areal recording density media, e.g., hard disks, utilizing granular-type magnetic recording layers.

### BACKGROUND OF THE INVENTION

Magnetic media are widely used in various applications, particularly in the computer industry for data/information storage and retrieval applications, typically in disk form, and efforts are continually made with the aim of increasing the areal recording density, i.e., bit density of the magnetic media. Conventional thin film thin-film type magnetic media, wherein a fine-grained polycrystalline magnetic alloy layer serves as the active recording layer, are generally classified as “longitudinal” or “perpendicular”, depending upon the orientation of the magnetic domains of the grains of magnetic material.

A portion of a conventional longitudinal recording, thin-film, hard disk-type magnetic recording medium 1 commonly employed in computer-related applications is schematically illustrated in FIG. 1 in simplified cross-sectional view, and comprises a substantially rigid, non-magnetic metal substrate 10, typically of aluminum (Al) or an aluminum-based alloy, such as an aluminum-magnesium (Al—Mg) alloy, having sequentially deposited or otherwise formed on a surface 10A thereof a plating layer 11, such as of amorphous nickel-phosphorus (Ni—P); a seed layer 12A of an amorphous or fine-grained material, e.g., a nickel-aluminum (Ni—Al) or chromium-titanium (Cr—Ti) alloy; a polycrystalline underlayer 12B, typically of Cr or a Cr-based alloy; a magnetic recording layer 13, e.g., of a cobalt (Co)-based alloy with one or more of platinum (Pt), Cr, boron (B), etc.; a protective overcoat layer 14, typically containing carbon (C), e.g., diamond-like carbon (“DLC”); and a lubricant topcoat layer 15, e.g., of a perfluoropolyether. Each of layers 11-14 may be deposited by suitable physical vapor deposition (“PVD”) techniques, such as sputtering, and layer 15 is typically deposited by dipping or spraying.

In operation of medium 1, the magnetic layer 13 is locally magnetized by a write transducer, or write “head”, to record and thereby store data/information therein. The write transducer or head creates a highly concentrated magnetic field which alternates direction based on the bits of information to be stored. When the local magnetic field produced by the write transducer is greater than the coercivity of the material of the recording medium layer 13, the grains of the polycrystalline material at that location are magnetized. The grains retain their magnetization after the magnetic field applied thereto by the write transducer is removed. The direction of the magnetization matches the direction of the applied magnetic field. The magnetization of the recording medium layer 13 can subsequently produce an electrical response in a read transducer, or read “head”, allowing the stored information to be read.

So-called “perpendicular” recording media have been found to be superior to the more conventional “longitudinal” media in achieving very high bit densities. In perpendicular magnetic recording media, residual magnetization is formed in a direction perpendicular to the surface of the magnetic medium, typically a layer of a magnetic material on a suitable substrate. Very high linear recording densities are obtainable by utilizing a “single-pole” magnetic transducer or “head” with such perpendicular magnetic media.

Efficient, high bit density recording utilizing a perpendicular magnetic medium requires interposition of a relatively thick (as compared with the magnetic recording layer), magnetically “soft” underlayer (“SUL”) layer, i.e., a magnetic layer having a relatively low coercivity below about 1 kOe, such as of a NiFe alloy (Permalloy), between the non-magnetic substrate, e.g., of glass, aluminum (Al) or an Al-based alloy, and the magnetically “hard” recording layer having relatively high coercivity, typically about 3-8 kOe, e.g., of a cobalt-based alloy (e.g., a Co—Cr alloy such as CoCrPtB) having perpendicular anisotropy. The magnetically soft underlayer serves to guide magnetic flux emanating from the head through the hard, perpendicular magnetic recording layer.

A typical conventional perpendicular recording system 20 utilizing a vertically oriented magnetic medium 21 with a relatively thick soft magnetic underlayer, a relatively thin hard magnetic recording layer, and a single-pole head, is illustrated in FIG. 2, wherein reference numerals 10, 11, 4, 5, and 6, respectively, indicate a non-magnetic substrate, an adhesion layer (optional), a soft magnetic underlayer, at least one non-magnetic interlayer, and at least one perpendicular hard magnetic recording layer. Reference numerals 7 and 8, respectively, indicate the single and auxiliary poles of a single-pole magnetic transducer head 6. The relatively thin interlayer 5 (also referred to as an “intermediate” layer), comprised of one or more layers of non-magnetic materials, serves to (1) prevent magnetic interaction between the soft underlayer 4 and the at least one hard recording layer 6 and (2) promote desired microstructural and magnetic properties of the at least one hard recording layer.

As shown by the arrows in the figure indicating the path of the magnetic flux φ, flux φ is seen as emanating from single pole 7 of single-pole magnetic transducer head 6, entering and passing through the at least one vertically oriented, hard magnetic recording layer 5 in the region below single pole 7, entering and traveling within soft magnetic underlayer 3 for a distance, and then exiting therefrom and passing through the at least one perpendicular hard magnetic recording layer 6 in the region below auxiliary pole 8 of single-pole magnetic transducer head 6. The direction of movement of perpendicular magnetic medium 21 past transducer head 6 is indicated in the figure by the arrow above medium 21.

With continued reference to FIG. 2, vertical lines 9 indicate grain boundaries of polycrystalline layers 5 and 6 of the layer stack constituting medium 21. Magnetically hard main recording layer 6 is formed on interlayer 5, and while the grains of each polycrystalline layer may be of differing widths (as measured in a horizontal direction) represented by a grain size distribution, they are generally in vertical registry (i.e., vertically “correlated” or aligned).

Completing the layer stack is a protective overcoat layer 14, such as of a diamond-like carbon (DLC), formed over hard magnetic layer 6, and a lubricant topcoat layer 15, such as of a perfluoropolyethylene material, formed over the protective overcoat layer.

Substrate 10 is typically disk-shaped and comprised of a non-magnetic metal or alloy, e.g., Al or an Al-based alloy, such as Al—Mg having an Ni—P plating layer on the deposition surface thereof, or substrate 10 is comprised of a suitable glass, ceramic, glass-ceramic, polymeric material, or a composite or laminate of these materials. Optional adhesion layer 11, if present, may comprise an up to about 30 Å thick layer of a material such as Ti or a Ti alloy. Soft magnetic underlayer 4 is typically comprised of an about 500 to about 4,000 Å thick layer of a soft magnetic material selected from the group consisting of Ni, NiFe (Permalloy), Co, CoZr, CoZrCr, CoZrNb, CoFeZrNb, CoFe, Fe, FeN, FeSiAl, FeSiAlN, FeCoB, FeCoC, etc. Interlayer 5 typically comprises an up to about 300 Å thick layer or layers of non-magnetic material(s), such as Ru, TiCr, Ru/CoCr₃₇Pt₆, RuCr/CoCrPt, etc.; and the at least one hard magnetic layer 6 is typically comprised of an about 100 to about 250 Å thick layer(s) of Co-based alloy(s) including one or more elements selected from the group consisting of Cr, Fe, Ta, Ni, Mo, Pt, V, Nb, Ge, B, and Pd, iron nitrides or oxides, or a (CoX/Pd or Pt)ₙ multilayer magnetic superlattice structure, where n is an integer from about 10 to about 25. Each of the alternating, thin layers of Co-based magnetic alloy of the superlattice is from about 2 to about 3.5 Å thick, X is an element selected from the group consisting of Cr, Ta, B, Mo, Pt, W, and Fe, and each of the alternating thin, non-magnetic layers of Pd or Pt is up to about 10 Å thick. Each type of hard magnetic recording layer material has perpendicular anisotropy arising from magneto-crystalline anisotropy (1^{st} type) and/or interfacial anisotropy (2^{nd} type).

A currently employed way of classifying magnetic recording media is on the basis by which the magnetic grains of the recording layer are mutually separated, i.e., segregated, in order to physically and magnetically de-couple the grains and provide improved media performance characteristics. According to this classification scheme, magnetic media with Co-based alloy magnetic recording layers (e.g., CoCr alloys) are classified into two distinct types: (1) a first type, wherein segregation of the grains occurs by diffusion of Cr atoms of the magnetic layer to the grain boundaries of the layer to form Cr-rich grain boundaries, which diffusion process requires heating of the media substrate during formation (deposition) of the magnetic layer; and (2) a second type, wherein segregation of the grains occurs by formation of oxides, nitrides, and/or carbides at the boundaries between adjacent magnetic grains to form so-called “granular” media, which oxides, nitrides, and/or carbides may be formed by introducing a minor amount of at least one reactive gas containing oxygen, nitrogen, and/or carbon atoms (e.g. O₂, N₂, CO₂, etc.) to the inert gas (e.g., Ar) atmosphere during sputter deposition of the Co alloy-based magnetic layer.

Magnetic recording media with granular magnetic recording layers possess great potential for achieving ultra-high areal recording densities. As indicated above, current methodology for manufacturing granular-type magnetic recording media involves reactive sputtering of the magnetic recording layer in a reactive gas-containing atmosphere, e.g., an O₂ and/or N₂ atmosphere, in order to incorporate oxides and/or nitrides therein and achieve smaller and more isolated magnetic grains. Corrosion and environmental testing of granular recording media indicate very poor resistance to corrosion and environmental influences and even relatively thick carbon-based protective overcoats, e.g., ˜40 Å thick, provide inadequate resistance to corrosion and environmental attack.

In view of the foregoing, there exists a clear need for methodology for manufacturing high areal recording density, high performance granular-type longitudinal and perpendicular magnetic recording media with improved corrosion resistance, which methodology is fully compatible with the requirements of high product throughput, cost-effective, automated manufacture of such high performance magnetic recording media.

The present invention, therefore, addresses and solves the above-described problems, drawbacks, and disadvantages associated with the above-described methodology for the manufacture of high performance magnetic recording media comprising granular-type magnetic recording layers, while maintaining full compatibility with all aspects of automated manufacture of magnetic recording media.

### DISCLOSURE OF THE INVENTION

An advantage of the present invention is improved methods of manufacturing granular longitudinal and perpendicular granular magnetic recording media with enhanced corrosion and environmental resistance.

Another advantage of the present invention is improved granular longitudinal and perpendicular magnetic recording media with enhanced corrosion and environmental resistance.

Additional advantages and other features of the present invention will be set forth in the description which follows and in part will become apparent to those having ordinary skill in the art upon examination of the following or may be learned from the practice of the present invention. The advantages of the present invention may be realized and obtained as particularly pointed out in the appended claims.

According to an aspect of the present invention, the foregoing and other advantages are obtained in part by a method of manufacturing granular magnetic recording media, comprising sequential steps of:
(a) providing a non-magnetic substrate including a surface;
(b) forming a layer stack on the surface of the substrate, the layer stack including an outermost granular magnetic recording layer with an exposed nano-scale rough and porous surface;
(c) treating the exposed nano-scale rough and porous surface of the granular magnetic recording layer to provide at least one of:
   (i) a reduction of the nano-scale roughness and porosity;
   (ii) increased compositional homogeneity;
   (iii) increased microstructural homogeneity;
   (iv) preferential removal of at least one element; and
   (v) increased grain boundary coverage by a subsequently deposited protective overcoat layer; and
(d) forming a protective overcoat layer on the treated surface of the granular magnetic recording layer.

According to preferred embodiments of the present invention, step (b) comprises forming a layer stack including an outermost granular longitudinal or perpendicular magnetic recording layer; step (c) comprises etching the surface of the granular magnetic recording layer, e.g., sputter etching with ions of an inert gas, such as Ar ions; step (d) comprises forming a carbon (C)-containing protective overcoat layer, e.g., a diamond-like carbon (DLC) protective overcoat layer, formed as by ion beam deposition (IBD); step (a) comprises providing a non-magnetic substrate comprised of a non-magnetic material selected from the group consisting of: Al, NiP-plated Al, Al—Mg alloys, other Al-based alloys, other non-magnetic metals, other non-magnetic alloys, glass, ceramics, polymers, glass-ceramics, and composites and/or laminates of the aforementioned materials; and step (b) comprises forming a layer stack including a granular Co-based alloy magnetic recording layer comprised of a CoPtX alloy, where X=at least one element or material selected from the group consisting of: Cr, Ta, B, Mo, V, Nb, W, Zr, Re, Ru, Cu, Ag, Hf, Ir, Y, O, Si, Ti, N, P, Ni, SiO₂, SiO, Si_{3N}₄, Al₂O₃, AlN, TiO, TiO₂, TiOₓ, TiN, TiC, Ta₂O₅, NiO, and CoO, and wherein Co-containing magnetic grains with hcp lattice structure are segregated by grain boundaries comprising at least one of oxides, nitrides, and carbides.

Preferred embodiments of the invention include those wherein the method further comprises a step of:
(e) forming a lubricant topcoat layer on the protective overcoat layer, e.g., comprising a layer of a perfluoropolyether material.

Another aspect of the present invention is a granular magnetic recording medium, comprising:
(a) a non-magnetic substrate having a surface;
(b) a layer stack on the substrate surface, the layer stack including a granular magnetic recording layer having a surface distal the substrate surface treated to provide at least one of:
   (i) a reduction of nano-scale roughness and porosity;
   (ii) increased compositional homogeneity;
   (iii) increased microstructural homogeneity;
   (iv) preferential removal of at least one element; and
   (v) increased grain boundary coverage by a subsequently deposited protective overcoat layer; and
(c) a protective overcoat layer on the treated surface of the granular magnetic recording layer.

According to preferred embodiments of the present invention, the granular magnetic recording layer is a longitudinal or a perpendicular magnetic recording layer; the distal surface of the granular magnetic recording layer is sputter etched with ions of an inert gas, e.g., Ar ions; the non-magnetic substrate comprises a non-magnetic material selected from the group consisting of: Al, NiP-plated Al, Al—Mg alloys, other Al-based alloys, other non-magnetic metals, other non-magnetic alloys, glass, ceramics, polymers, glass-ceramics, and composites and/or laminates of the aforementioned materials; the granular Co-based alloy magnetic recording layer comprises a CoPtX alloy, where X=at least one element or material selected from the group consisting of: Cr, Ta, B, Mo, V, Nb, W, Zr, Re, Ru, Cu, Ag, Hf. Ir, Y, O, Si, Ti, N, P, Ni, SiO₂, SiO, Si₃N₄, Al₂O₃, AlN, TiO, TiO₂, TiOₓ, TiN, TiC, Ta₂O₅, NiO, and CoO, and wherein Co-containing magnetic grains are segregated by grain boundaries comprising at least one of oxides, nitrides, and carbides; and the protective overcoat layer comprises a carbon (C)-containing material, e.g., a diamond-like carbon (DLC) material such as an ion beam deposited (IBD) DLC material.

In accordance with further preferred embodiments of the invention, the medium further comprises:
(d) a lubricant topcoat layer on the protective overcoat layer, comprised of a perfluoropolyether material.

Additional advantages and aspects of the present invention will become readily apparent to those skilled in the art from the following detailed description, wherein embodiments of the present invention are shown and described, simply by way of illustration of the best mode contemplated for practicing the present invention. As will be described, the present invention is capable of other and different embodiments, and its several details are susceptible of modification in various obvious respects, all without departing from the spirit of the present invention. Accordingly, the drawings and description are to be regarded as illustrative in nature, and not as limitative.

### BRIEF DESCRIPTION OF THE DRAWINGS

The following detailed description of the embodiments of the present invention can best be understood when read in conjunction with the following drawings, in which the various features are not necessarily drawn to scale but rather are drawn as to best illustrate the pertinent features, wherein:

FIG. 1 schematically illustrates, in simplified cross-sectional view, a portion of a conventional thin film longitudinal magnetic recording medium;

FIG. 2 schematically illustrates, in simplified cross-sectional view, a portion of a magnetic recording storage, and retrieval system comprised of a perpendicular magnetic recording medium and a single pole transducer head;

FIGS. 3(A)-3(B) are photomicrographs illustrating the grain topography of samples of granular perpendicular magnetic recording layers before and after Ar ion sputter etching, respectively, as measured by Atomic Force Microscopy (AFM) using a carbon nano-tube as a probe;

FIG. 4 is a graph showing the variation of the power spectra of granular magnetic recording layers as a function of Ar sputter etching interval;

FIG. 5 is a bar graph showing the variation of the nano-scale roughness of granular magnetic recording layers as a function of Ar sputter etching interval, as measured by AFM;

FIGS. 6(A)-6(B) are cross-sectional photomicrographic images of samples of granular perpendicular magnetic recording layers (capped with 30 Å thick Ru layers) before and after Ar ion sputter etching, respectively, as obtained by transmission electron microscopy (TEM); and

FIGS. 7(A)-7(B) are photomicrographs illustrating the grain topography of samples of granular perpendicular magnetic recording layers with and without Ar ion sputter etching, respectively, after a 4-day exposure to an 80° C./80% relative humidity (RH) environment, as measured by Atomic Force Microscopy (AFM).

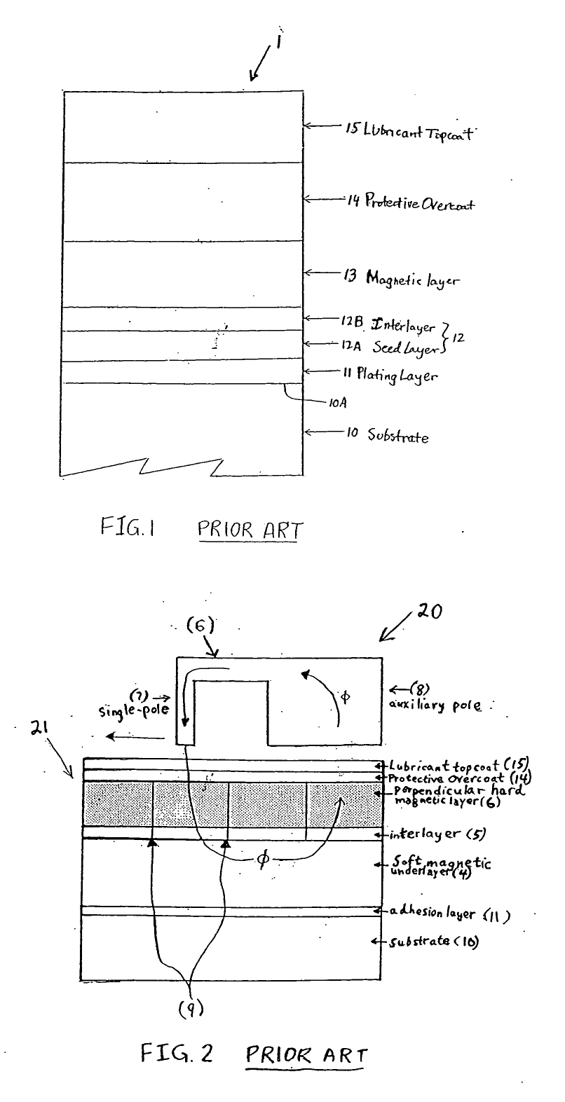

### DESCRIPTION OF THE INVENTION

The present invention addresses and solves problems, disadvantages, and drawbacks associated with the poor corrosion and environmental resistance of granular longitudinal and perpendicular magnetic recording media fabricated according to prior methodologies, and is based upon recent investigations by the present inventors which have determined that the underlying cause of the poor corrosion performance of such media is attributable, inter alia, to incomplete surface coverage of the protective overcoat layer (typically of a DLC material) arising from increased nano-scale roughness of the granular magnetic recording layer relative to that of several other types magnetic recording layers, the presence of porous grain boundaries, and poor adhesion of the protective overcoat layer at the grain boundaries.

The present invention is further based upon recognition by the present inventors that the aforementioned problems of poor corrosion and environmental resistance of granular magnetic recording layers can be mitigated, if not entirely eliminated, by performing a suitable treatment of the surface thereof prior to formation thereon of the protective overcoat layer. More specifically, the inventors have determined that the corrosion resistance of such media may be significantly improved by etching the surface of granular magnetic recording layers with ions of an inert gas, e.g., Ar ions, for a sufficient interval to effect removal of a surface portion of the layers via sputter etching to effect at least one of the following:
(i) a reduction of the nano-scale roughness and porosity of the layer;
(ii) increased compositional homogeneity of the layer;
(iii) increased microstructural homogeneity of the layer;
(iv) preferential removal of at least one constituent, e.g., Co atoms, from the layer; and
(v) increased grain boundary coverage by the subsequently deposited protective overcoat layer.

The principles of the present invention will now be described in detail by reference to the following illustrative, but not limitative, example of the inventive methodology. According to the invention, magnetic media with layer stacks including an outermost granular longitudinal or perpendicular magnetic recording film or layer, illustratively (but not limitatively) comprised of a CoPtX alloy, where X=at least one element or material selected from the group consisting of: Cr, Ta, B, Mo, V, Nb, W, Zr, Re, Ru, Cu, Ag, Hf, Ir, Y, O, Si, Ti, N, P, Ni, SiO₂, SiO, Si₃N₄, Al₂O₃, AlN, TiO, TiO₂, TiOₓ, TiN, TiC, Ta₂O₅, NiO, and CoO, and wherein Co-containing magnetic grains are segregated by grain boundaries comprising at least one of oxides, nitrides, and carbides were formed (e.g., by reactive sputtering) on the surfaces of disk-shaped non-magnetic substrates comprised of a non-magnetic material selected from the group consisting of: Al, NiP-plated Al, Al—Mg alloys, other Al-based alloys, other non-magnetic metals, other non-magnetic alloys, glass, ceramics, polymers, glass-ceramics, and composites and/or laminates of the aforementioned materials.

After deposition of the CoPtX alloy films or layers serving as the granular longitudinal or perpendicular magnetic recording films or layers was complete, the exposed upper surfaces thereof were subjected to an ion etching treatment, i.e., sputter etching with inert ions (illustratively Ar ions) for specified intervals to effect at least one of the following:
(i) reduction of the surface nano-scale roughness and porosity of the CoPtX alloy layer;
(ii) increased compositional homogeneity of the CoPtX alloy;
(iii) increased microstructural homogeneity of the CoPtX alloy layer;
(iv) preferential removal of at least one constituent, e.g., Co atoms, of the CoPtX alloy layer; and
(v) increased coverage of the grain boundaries of the CoPtX alloy layer by the subsequently deposited carbon-based protective overcoat layer.

The sputter (ion) etching of the surface of the CoPtX alloy films or layers was performed with ions derived from Ar gas supplied at a flow rate of 30 sccm, at 120 V substrate bias, and for intervals ranging from 0 to 10 sec. Upon completion of the ion etching treatment, the disks were coated with a 30 Å thick layer of IBD DLC carbon (I—C:H). The process conditions are summarized in Table I below.

TABLE I

| | Magnetic | Ar | Substrate | Etching | Overcoat | Overcoat |
|---|---|---|---|---|---|---|
| Sample | Recording | Flow, | Etching | Interval, | Layer | Thickness, |
| No. | Layer | sccm | Bias, V | sec. | Type | Å |
| 1 | Granular | 0 | 120 | 0 | I-C:H | 30 |
| 2 | Granular | 30 | 120 | 1 | I-C:H | 30 |
| 3 | Granular | 30 | 120 | 5 | I-C:H | 30 |
| 4 | Granular | 30 | 120 | 10 | I-C:H | 30 |

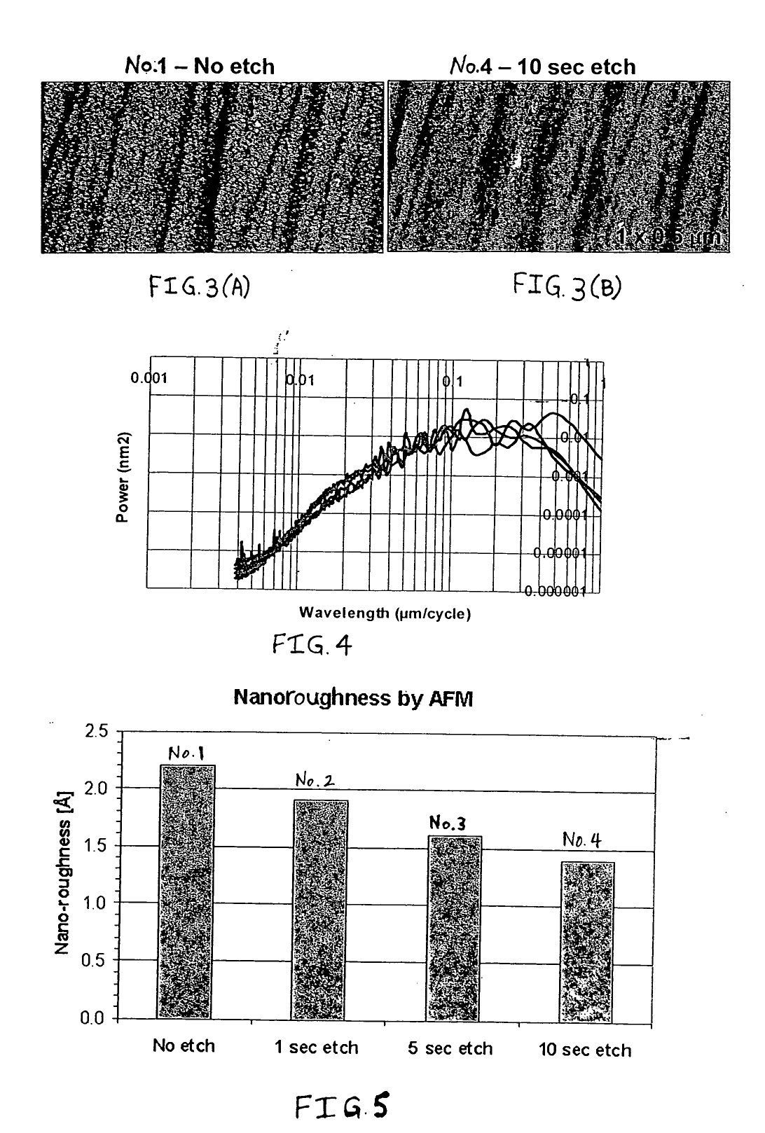

Referring now to FIGS. 3(A)-3(B), shown therein are photomicrographs illustrating the grain topography of samples 1 and 4 of Table I before (i.e., 0 sec.) and after (i.e., 10 sec.) Ar ion sputter etching, respectively, as measured by Atomic Force Microscopy (AFM) using a carbon nano-tube as a probe. As is evident from the figures, as the ion etching interval is increased, the sharp features of the grains at the boundaries between adjacent grains become blurred, indicating smoother surfaces.

Adverting to FIGS. 4 and 5, the former is a graph showing the variation of the power spectra of the roughness of the sputter (ion) etched granular magnetic recording layers of samples 1 and 4 of Table I, as a function of Ar sputter etching interval; and the latter is a bar graph showing the variation of the nano-scale roughness of the granular magnetic recording layers of samples 1 and 4 of Table I, as a function of Ar sputter etching interval, as measured by AFM. In each instance, it is evident that sample No. 4 subjected to sputter (ion) etching exhibits significantly reduced surface nano-scale roughness.

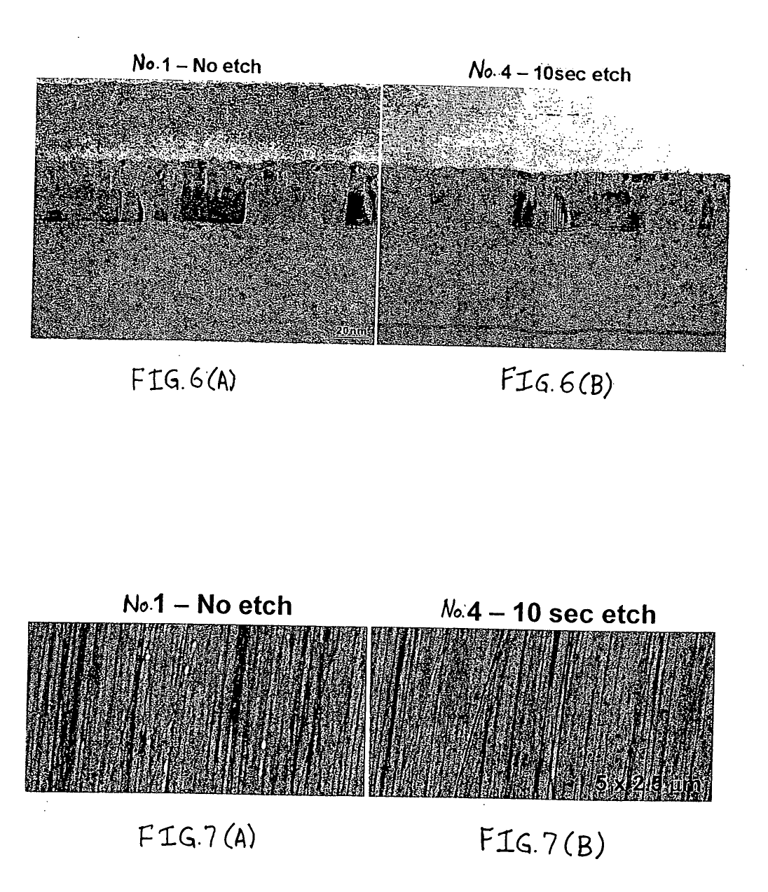

Referring to FIGS. 6(A)-6(B), shown therein are cross-sectional photomicrographic images of the granular perpendicular magnetic recording films or layers (capped with 30 Å thick Ru layers) of samples 1 and 4 of Table 1 before and after Ar ion sputter etching, respectively, as obtained by transmission electron microscopy (TEM), which TEM images confirm the above results. Specifically, the magnetic recording film or layer of sample No. 1 (i.e., before ion etching) exhibits the very rough surface topology characteristic of as-deposited granular magnetic recording films or layers, whereas the granular magnetic recording film or layer of sample No. 4 (i.e., after 10 sec. ion etching) exhibits a very smooth surface topology attributed to the Ar ion etching.

FIGS. 7(A)-7(B) are photomicrographs illustrating the grain topography of the granular perpendicular magnetic recording films or layers of samples 1 and 4 of Table I with and without Ar ion sputter etching, respectively, after a 4-day exposure to an 80° C./80% relative humidity (RH) environment, as measured by Atomic Force Microscopy (AFM). As is evident therefrom, the white corrosion-indicating spots in the pre-etch sample No. 1 of FIG. 7(A) are absent from the ion etched sample No. 4 of FIG. 7(B), indicating increased corrosion resistance provided by the I—C:H protective overcoat layer. A thin lubricant topcoat layer, typically of a perfluoropolyether material, is formed over the I—C:H protective overcoat layer prior to installation and use of the thus-formed (i.e., ion etched) media in a disk drive system.

It should be noted that the above-described embodiment of the inventive methodology is merely illustrative, and not limitative, of the advantageous results afforded by the invention. Specifically, the inventive methodology is not limited to use with the illustrated CoPtX magnetic alloys, but rather is useful in providing enhanced corrosion and environmental resistance of recording media comprising all manner of granular longitudinal or perpendicular magnetic recording layers having surfaces with nano-scale roughness and porosity. Similarly, the ion etching treatment of the invention is not limited to use with the illustrated Ar ions, and satisfactory ion etching may be performed with numerous other inert ion species, including, for example, He, Kr, Xe, and Ne ions. In addition, specific process conditions for performing the ion etching are readily determined for use in a particular application of the inventive methodology, including selection of the rate of flow of the inert gas, substrate bias voltage, ion etching interval, ion energy, and etching rate. For example, suitable ranges of substrate bias voltages, ion energies, and etching rates are 0-300 V, 10-400 eV, and 0.1-20 Å/sec., respectively.

In the previous description, numerous specific details are set forth, such as specific materials, structures, processes, etc., in order to provide a better understanding of the present invention. However, the present invention can be practiced without resorting to the details specifically set forth. In other instances, well-known processing materials and techniques have not been described in detail in order not to unnecessarily obscure the present invention.

Only the preferred embodiments of the present invention and but a few examples of its versatility are shown and described in the present disclosure. It is to be understood that the present invention is capable of use in various other combinations and environments and is susceptible of changes and/or modifications within the scope of the inventive concept as expressed herein.

1. A method of manufacturing granular magnetic recording media, comprising sequential steps of:
(a) providing a non-magnetic substrate including a surface;
(b) forming a layer stack on said surface of said substrate, said layer stack including an outermost granular magnetic recording layer with an exposed nano-scale rough and porous surface;
(c) treating said exposed nano-rough and porous surface of said granular magnetic recording layer to provide at least one of:
(i) a reduction of said nano-scale roughness and porosity;
(ii) increased compositional homogeneity;
(iii) increased microstructural homogeneity;
(iv) preferential removal of at least one element; and
(v) increased grain boundary coverage by a subsequently deposited protective overcoat layer; and
(d) forming a protective overcoat layer on the treated surface of said granular magnetic recording layer.

2. The method according to claim 1, wherein:
step (b) comprises forming a layer stack including an outermost granular perpendicular magnetic recording layer.

3. The method according to claim 1, wherein:
step (b) comprises forming a layer stack including an outermost granular longitudinal magnetic recording layer.

4. The method according to claim 1, wherein:
step (c) comprises etching said surface of said granular magnetic recording layer.

5. The method according to claim 4, wherein:
step (c) comprises sputter etching said surface.

6. The method according to claim 5, wherein:
step (c) comprises sputter etching said surface with ions of an inert gas.

7. The method according to claim 6, wherein:
step (c) comprises sputter etching said surface with Ar ions.

8. The method according to claim 1, wherein:
step (d) comprises forming a carbon (C)-containing protective overcoat layer.

9. The method according to claim 8, wherein:
step (d) comprises forming a diamond-like carbon (DLC) protective overcoat layer.

10. The method according to claim 9, wherein:
step (d) comprises forming said DLC protective overcoat layer by ion beam deposition (IBD).

11. The method according to claim 1, wherein:
step (a) comprises providing a non-magnetic substrate comprised of a non-magnetic material selected from the group consisting of: Al, NiP-plated Al, Al—Mg alloys, other Al-based alloys, other non-magnetic metals, other non-magnetic alloys, glass, ceramics, polymers, glass-ceramics, and composites and/or laminates of the aforementioned materials.

12. The method according to claim 1, wherein:
step (b) comprises forming a layer stack including a granular Co-based alloy magnetic recording layer comprised of a CoPtX alloy, where X=at least one element or material selected from the group consisting of: Cr, Ta, B, Mo, V, Nb, W, Zr, Re, Ru, Cu, Ag, Hf, Ir, Y, O, Si, Ti, N, P, Ni, SiO₂, SiO, Si₃N₄, Al₂O₃, AlN, TiO, TiO₂, TiOₓ, TiN, TiC, Ta₂O₅, NiO, and CoO, and wherein Co-containing magnetic grains are segregated by grain boundaries comprising at least one of oxides, nitrides, and carbides.

13. The method according to claim 1, further comprising a step of:
(e) forming a lubricant topcoat layer on said protective overcoat layer.

14. The method according to claim 13, wherein:
step (e) comprises forming a layer of a perfluoropolyether material.

15. A granular magnetic recording medium, comprising:
(a) a non-magnetic substrate having a surface;
(b) a layer stack on said substrate surface, said layer stack including a granular magnetic recording layer having a surface distal said substrate surface treated to provide at least one of:
(i) a reduction of nano-scale roughness and porosity;
(ii) increased compositional homogeneity;
(iii) increased microstructural homogeneity;
(iv) preferential removal of at least one element; and
(v) increased grain boundary coverage by a subsequently deposited protective overcoat layer; and
(c) a protective overcoat layer on the treated surface of said granular magnetic recording layer.

16. The medium as in claim 15, wherein:
said granular magnetic recording layer is a longitudinal magnetic recording layer.

17. The medium as in claim 15, wherein:
said granular magnetic recording layer is a perpendicular magnetic recording layer.

18. The medium as in claim 15, wherein:
said distal surface of said magnetic recording layer is sputter etched with ions of an inert gas.

19. The medium as in claim 15, wherein:
said non-magnetic substrate comprises a non-magnetic material selected from the group consisting of: Al, NiP-plated Al, Al—Mg alloys, other Al-based alloys, other non-magnetic metals, other non-magnetic alloys, glass, ceramics, polymers, glass-ceramics, and composites and/or laminates of the aforementioned materials.

20. The medium as in claim 1, wherein:
said granular Co-based alloy magnetic recording layer comprises a CoPtX alloy, where X=at least one element or material selected from the group consisting of: Cr, Ta, B, Mo, V, Nb, W, Zr, Re, Ru, Cu, Ag, Hf, Ir, Y, O, Si, Ti, N, P, Ni, SiO₂, SiO, Si₃N₄, Al₂O₃, AlN, TiO, TiO₂, TiOₓ, TiN, TiC, Ta₂O₅, NiO, and CoO, and wherein Co-containing magnetic grains are segregated by grain boundaries comprising at least one of oxides, nitrides, and carbides.

21. The medium as in claim 15, wherein:
said protective overcoat layer comprises a carbon (C)-containing material.

22. The medium as in claim 21, wherein:
said protective overcoat layer comprises a diamond-like carbon (DLC) material.

23. The medium as in claim 22, wherein:
said protective overcoat layer comprises an ion beam deposited (IBD) DLC material.

24. The medium as in claim 15, further comprising:
(d) a lubricant topcoat layer on said protective overcoat layer.

25. The medium as in claim 24, wherein:
said lubricant topcoat layer comprises a perfluoropolyether material.
